(19) United States
(12) Patent Application Publication
(10) Pub. No.: US 2006/0265229 A1
(43) Pub. Date: Nov. 23, 2006

(54) Client schedule information management system

(76) Inventor: Shuichiro Nishino, Tokyo (JP)

Correspondence Address: ARENT FOX PLLC, 1050 CONNECTICUT AVENUE, N.W., SUITE 400, WASHINGTON, DC, 20036, US

(21) Appl. No.: 10/553,186

(22) PCT Filed: Apr. 20, 2004
(86) PCT No.: PCT/JP04/05618

§ 371 Date: Jul. 18, 2006

(51) Int. Cl. G06Q 99/00

(52) U.S. Cl. 705/1

(57) ABSTRACT

A customer planning information management system is provided in which customer planning information storage means (15) stores a plurality of types of customer planning information (planning for customer visits to a place of business or planning for staff members visiting customers) inputted via customer planning information input means (16), and customer scheduling means (24) automatically creates a customer schedule by selecting, among the customer planning information stored in the customer planning information storage means (15), only a predetermined type of customer planning information on a predetermined date. This enables business efficiency to be enhanced by sending to staff members customer schedules that are easy to use, without requiring manual extraction of customer planning information at a predetermined date from various types of customer planning information and manual extraction of a predetermined type of customer planning information.

### FIELD OF THE INVENTION

The present invention relates to a customer information management system for sales company staff to manage schedule information about their customers.

### BACKGROUND ART

An arrangement in which a date after a predetermined number of days has elapsed since a customer has visited a hair salon is estimated as a planned visit date for the customer to next visit the salon, and direct mail is dispatched to customers corresponding to that date so as to increase the percentage of repeat business from the customers and, in addition, when a customer makes an appointment to visit the salon, the name of the person responsible at the hair salon, the appointment time, and details of the appointment procedure (cut, permanent, straight permanent, coloring, aesthetic treatment, blow-wave, etc.) are inputted, and the appointment situation for that day can be understood from a display on a planning information detail screen of a computer terminal, is known from the patent document below.

[Patent Document]

Japanese Patent Application Laid-open No. 2002-133078

In the above-mentioned conventional arrangement, since the planned visit date for the customer to next visit the salon is estimated based on general intervals between procedures, and the intervals between procedures vary among customers, the reliability of the planned visit date is low, and there is a possibility that a sufficient effect might not be obtained even by planning the dispatch of direct mail based on the planned visit date. Furthermore, since many types of procedures (cut, permanent, straight permanent, coloring, aesthetic treatment, blow-wave, etc.) are displayed simultaneously on the planning information detail screen of the computer terminal, there is the problem that it is necessary to take care to differentiate between them, thus reducing the ease of use.

### DISCLOSURE OF THE INVENTION

The present invention has been accomplished under the above-mentioned circumstances, and it is an object thereof to enable a customer schedule that includes predetermined types of customer planning information on predetermined dates to be automatically created.

In order to attain the above object, according to a first aspect of the present invention, there is provided a customer planning information management system comprising: customer planning information input means for inputting a plurality of types of customer planning information; customer planning information storage means for storing the customer planning information inputted by the customer planning information input means; and customer scheduling means for creating a customer schedule by selecting, among the customer planning information stored in the customer planning information storage means, a predetermined type of customer planning information on a predetermined date.

In accordance with this arrangement, since the customer planning information storage means stores the plurality of types of customer planning information inputted from the customer planning information input means, and the customer scheduling means selects, among the customer planning information stored in the customer planning information storage means, only the predetermined type of customer planning information on the predetermined date and automatically creates the customer schedule, it is unnecessary to manually extract, from the plurality of types of customer planning information, the customer planning information on the predetermined date or the predetermined type of customer planning information, and an easy-to-use customer schedule can be delivered to a staff member, thus enhancing work efficiency. Moreover, since all staff members share the information, administrative efficiency is improved, and customer satisfaction is increased.

According to a second aspect of the present invention, in addition to the first aspect, there is provided a customer planning information management system, wherein the predetermined type of customer planning information includes at least information about a visit from a customer to a place of business.

In accordance with this arrangement, since the customer schedule that includes at least the information about a visit from a customer to a place of business is created, the schedule for customer visits to the place of business can be understood with certainty.

According to a third aspect of the present invention, in addition to the first aspect, there is provided a customer planning information management system, wherein it further comprises: responsible staff member setting means for setting a responsible staff member for a customer; responsible staff member storage means for storing the responsible staff member for the customer set by the responsible staff member setting means; and staff member personal schedule creating means for creating a personal schedule for the responsible staff member stored in the responsible staff member storage means; the staff member personal schedule creating means creating the personal schedule for the responsible staff member by automatically incorporating the customer schedule created by the customer scheduling means.

In accordance with this arrangement, when the staff member personal schedule creating means creates a personal schedule for the responsible staff member stored in the responsible staff member storage means set by the responsible staff member setting means, since the customer schedule created by the customer scheduling means is automatically incorporated, it is possible to reliably incorporate the customer planning information included in the customer schedule into the personal schedule of the responsible staff member, thereby reliably preventing a scheduling mistake from occurring. Furthermore, when creating a personal schedule, since contact information of other staff members can be referred to, scheduling is possible with higher accuracy.

According to a fourth aspect of the present invention, in addition to the first aspect, there is provided a customer planning information management system, wherein it further comprises; history input means for inputting at least a history of interviews with a customer; customer history storage means for storing the history inputted by the history input means; and follow-up staff member setting means for automatically setting a follow-up staff member who replaces a main responsible staff member for the customer based on the history of responding to the customer stored in the customer history storage means.

In accordance with this arrangement, since the follow-up staff member setting means automatically sets a follow-up staff member for replacing the main responsible staff member for the customer based on the history of responding to the customer inputted from the history input means and stored in the customer history storage means, even when the main responsible staff member is absent, it is possible to set a follow-up staff member who is known to the customer and enable smooth communication between the customer and the follow-up staff member, thus enhancing the customer satisfaction.

### BRIEF DESCRIPTION OF THE DRAWINGS

FIG. 1 to FIG. 11 show one embodiment of the present invention;

FIG. 1 is a block diagram of a customer planning information management system,

FIG. 2 is a diagram showing information stored in customer information storage means,

FIG. 3 is a diagram showing information stored in product ownership information storage means,

FIG. 4 is a diagram showing information stored in customer planning information storage means,

FIG. 5 is a diagram showing information stored in customer history storage means,

FIG. 6 is a diagram showing a schedule created by customer scheduling means,

FIG. 7 is a diagram showing a schedule created by staff member personal schedule creating means,

FIG. 8 is a diagram showing the contents of an electronic mail received by mail receiving means,

FIG. 9 is a diagram showing information stored in work request information storage means,

FIG. 10 is a diagram showing entries inputted by customer planning information input means, and

FIG. 11 is a diagram for explaining a method for setting a follow-up staff member.

### BEST MODE FOR CARRYING OUT THE INVENTION

A mode for carrying out the present invention is explained below by reference to an embodiment of the present invention shown in the attached drawings.

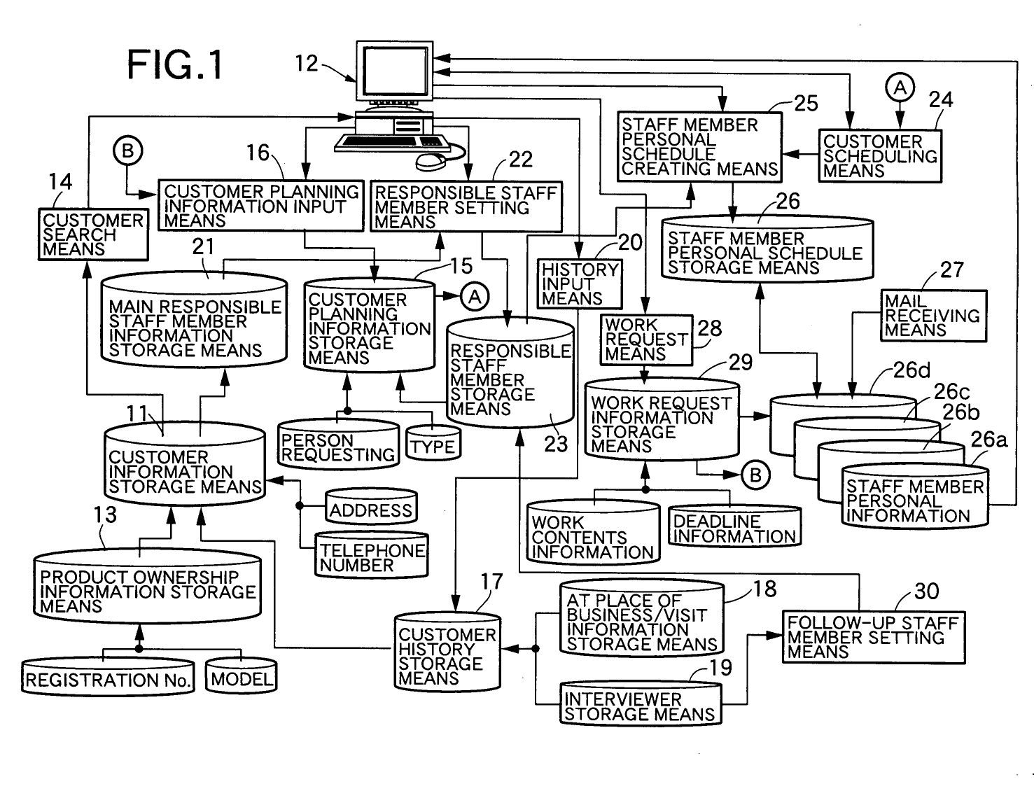

FIG. 1 to FIG. 11 show one embodiment of the present invention.

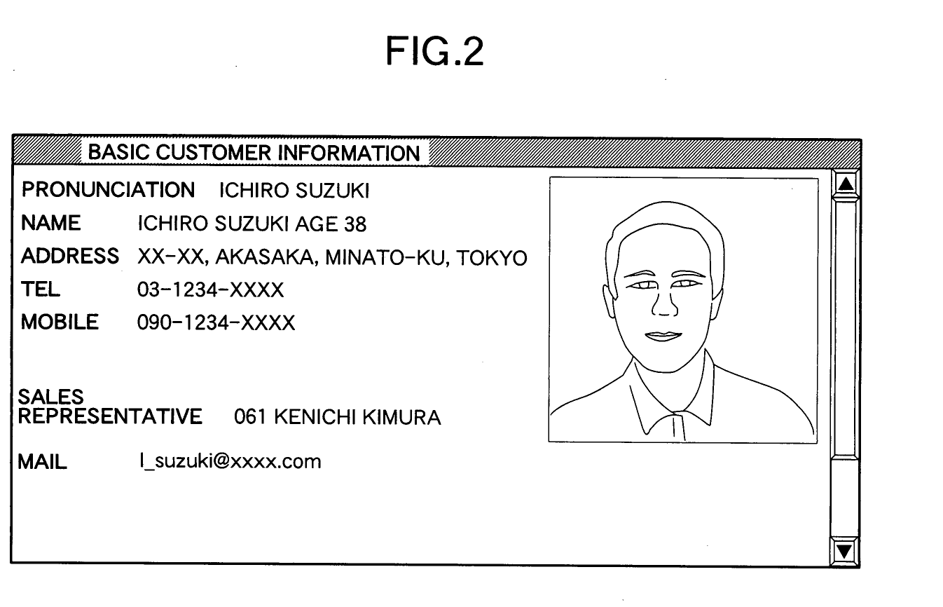

As shown in FIG. 1, a customer information management system used by an automobile sales company, etc. includes customer information storage means 11 for storing various types of information related to all customers of the sales company. FIG. 2 shows a screen of a monitor of a computer terminal 12 on which customer information about Mr. Suzuki, who is one of the customers, is displayed, the customer information including Mr. Suzuki's photograph, name, address, land-line telephone number, and mobile telephone number, name of the responsible staff member at the sales company, mail address, etc.

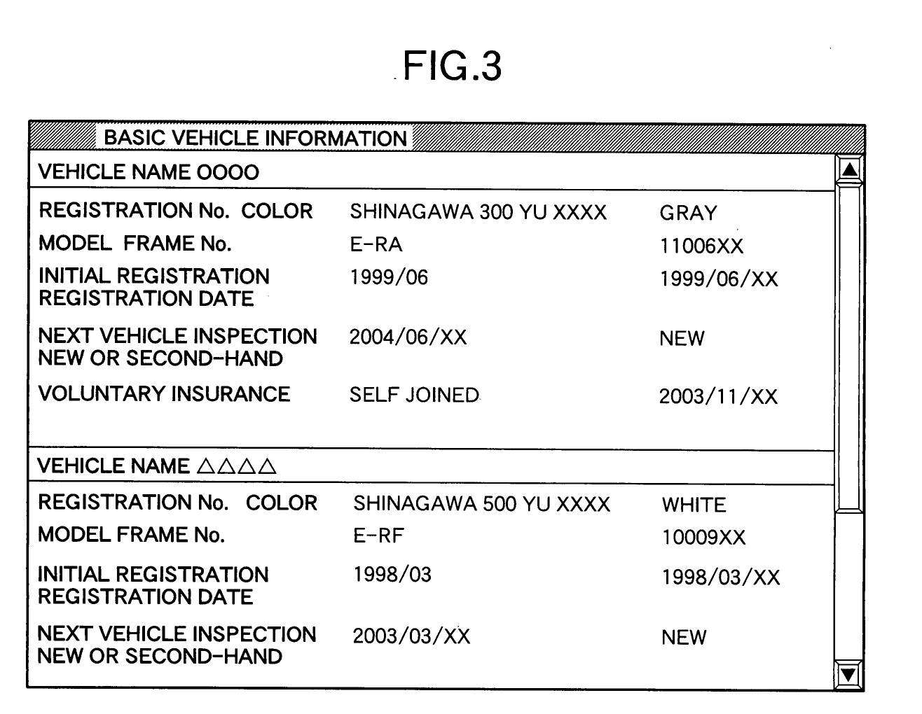

Connected to the customer information storage means 11 is product ownership information storage means 13. FIG. 3 shows a screen of the monitor of the computer terminal 12 on which product ownership information for Mr. Suzuki is displayed, the product ownership information including automobile name, registration number, color of vehicle body, model, frame number, initial year of registration date, next vehicle inspection date, whether it is new or second-hand, information related to voluntary insurance, etc.

Customer search means 14 searches for information about a specified customer from the contents stored in the customer information storage means 11 and the product ownership information storage means 13 using, as a keyword, the name, address, telephone number, etc. of the customer, and displays the information on the monitor of the computer terminal 12.

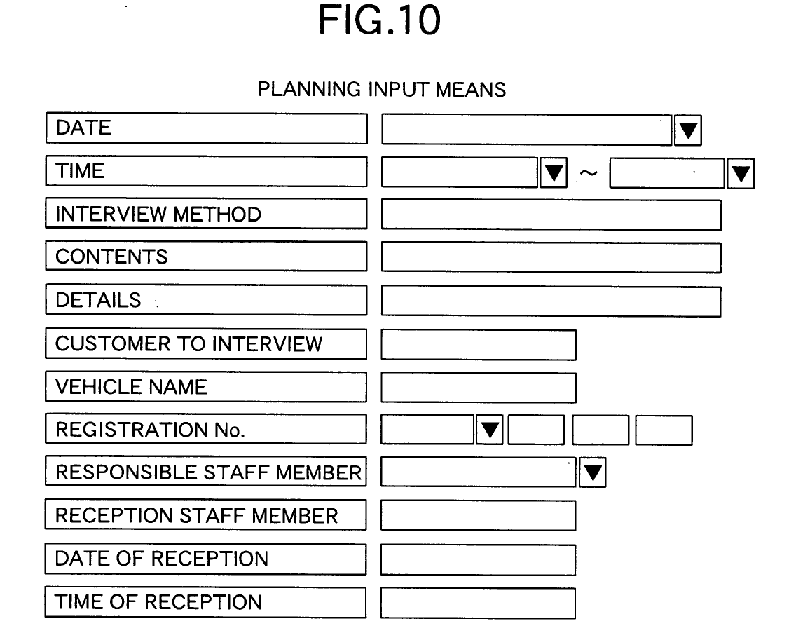

Customer planning information is inputted from customer planning information input means 16 into customer planning information storage means 15. FIG. 10 shows the contents of the customer planning information input means 16, and in the case of planning for a business discussion with a customer, the date, time, and method of the interview (at the place of business, visit, telephone, etc.), contents, details, the customer name, vehicle name, registration number, the responsible staff member, the reception staff member (person requesting), the reception date, and the reception time are inputted.

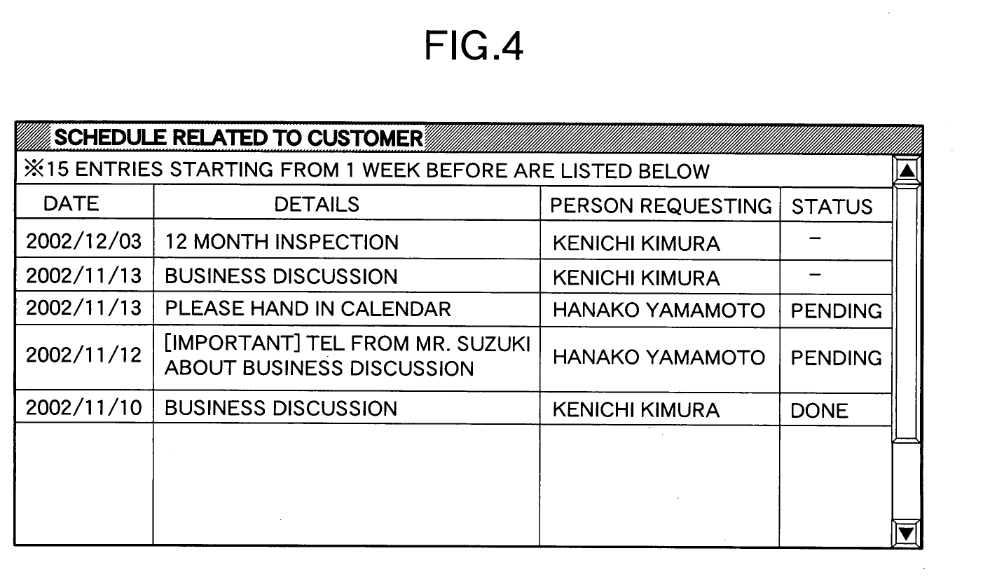

FIG. 4 shows a screen of the monitor of the computer terminal 12 on which customer planning information is displayed, displaying a maximum of 15 entries for planning information about Mr. Suzuki, who is a customer, from a week before the present date (November 13th) to the future. The person requesting seen on this screen is the reception staff member who has inputted the information via the customer planning information input means 16.

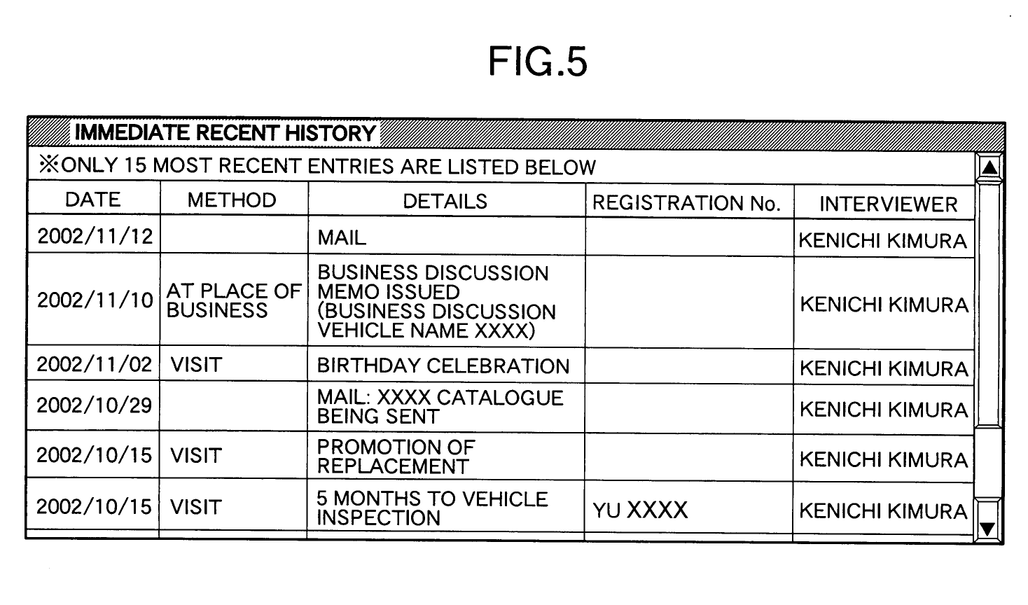

Connected to customer history storage means 17 are place of business/visit information storage means 18 and interviewer storage means 19, and stored in each of the storage means 17, 18, and 19 is the history of responding to each customer inputted via history input means 20. FIG. 5 shows a screen of the monitor of the computer terminal 12 on which customer history information for Mr. Suzuki is displayed, the information including method of interview (at place of business, visit, telephone, etc), details of the interview, name of the staff member who interviewed him, etc. The customer history storage means 17 is connected to the customer information storage means 11, and the history of each customer can be referred to by the computer terminal 12 via the customer search means 14.

Among the customer information stored in the customer information storage means 11, information about the responsible staff member is stored as main responsible staff member information in main responsible staff member information storage means 21, and the main responsible staff member information stored in the main responsible staff member information storage means 21 is inputted into responsible staff member setting means 22. The responsible staff member setting means 22 is connected to the computer terminal 12, and the main responsible staff member can also be set or modified via the computer terminal 12.

Stored in responsible staff member storage means 23 is the main responsible staff member set by the responsible staff member setting means 22. The responsible staff member stored in the customer planning information storage means 15 is originally a responsible staff member inputted from the customer planning information input means 16, but the original responsible staff member is updated each time the responsible staff member stored in the responsible staff member storage means 23 is modified.

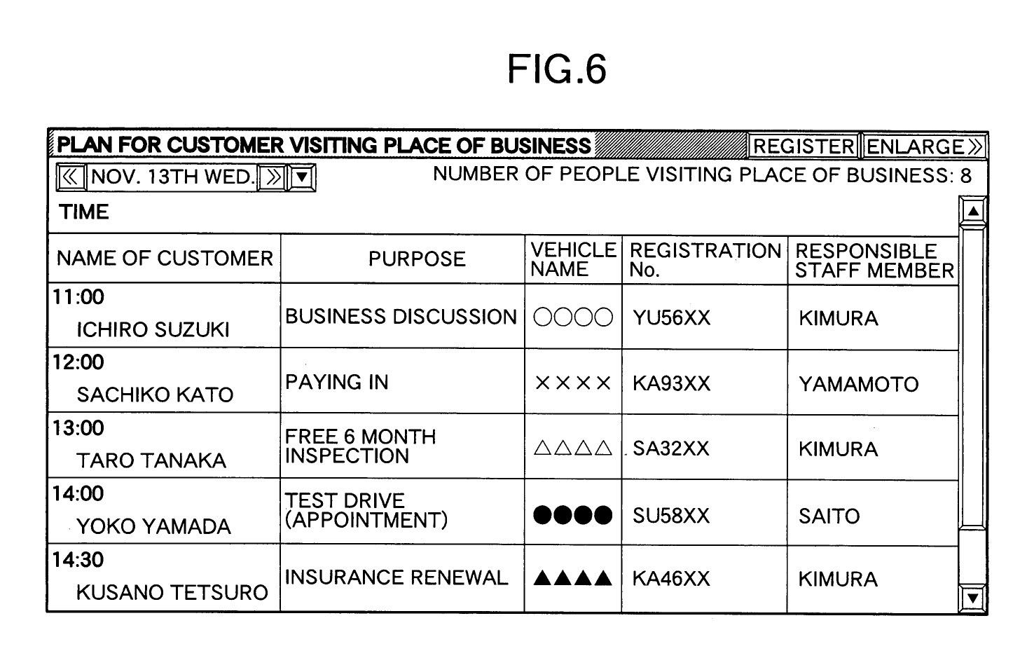

Customer scheduling means 24 connected to the customer planning information storage means 15 selects predetermined information from the information stored in the customer planning information storage means 15, and sets a schedule for responsible staff members interviewing customers on the present date. FIG. 6 shows a screen of the monitor of the computer terminal 12 on which the schedule for November 13th set by the customer scheduling means 24 is displayed, the schedule including Mr. Kimura, who is a responsible staff member, interviewing Mr. Suzuki, who is a customer, at 11:00 for a business discussion, Ms. Yamamoto, who is a responsible staff member, interviewing Ms. Kato, who is a customer, at 12:00 for paying in, Mr. Kimura, who is a responsible staff member, interviewing Mr. Tanaka, who is a customer, at 13:00 for a free six month inspection, Mr. Saito, who is a responsible staff member, interviewing Ms. Yamada, who is a customer, at 14:00 for a test drive, and Mr. Kimura, who is a responsible staff member, interviewing Mr. Kusano, who is a customer, at 14:30 for insurance renewal.

In this way, among various types of information inputted individually by a plurality of staff members and stored in the customer planning information storage means 15, only the schedules of interviews with customers who are to visit the place of business on the present date are automatically selected and displayed in chronological order, and it is therefore possible for each staff member of the sales company to easily understand all of the schedules for interviews with customers by responsible staff members planned for that date.

In an example of FIG. 6, as the type of schedule, interviews with customers who are to visit the place of business is selected, but any type of schedule can be selected and, for example, a schedule for responsible staff members visiting customers, a schedule for telephoning customers, a schedule for transmitting mail to customers, or a schedule for sending post to customers may be selected.

Each staff member creates their own personal schedule with staff member personal schedule creating means 25 connected to the computer terminal 12, and stores the personal schedule in staff member personal schedule storage means 26, which is a collection of staff member personal information 26a, 26b, 26c, etc. During this process, among the schedules set by the customer scheduling means 24, the schedules for the responsible staff members are automatically incorporated. The staff member personal information 26a, 26b, 26c, etc. is made for each individual, including the head of the sales company, sales staff, mechanics staff, and reception staff.

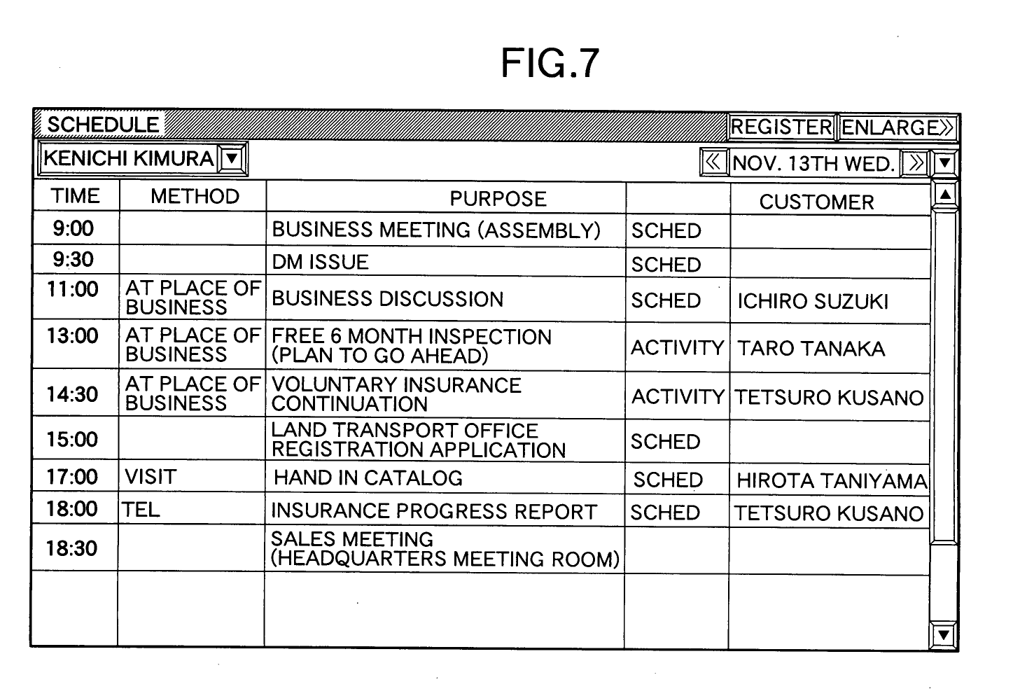

FIG. 7 shows the screen of the monitor of the computer terminal 12 on which a personal schedule on November 13th for Mr. Kimura, who is a staff member, is displayed, the schedule including a visit by a customer to the place of business, a visit to a customer, a telephone call to a customer, etc. The schedule for Mr. Kimura, who is a staff member, interviewing Mr. Suzuki, who is a customer, displayed on second line in FIG. 4 is reflected on the third line in FIG. 7.

In this way, when the staff member personal schedule creating means 25 creates a schedule for a responsible staff member who has been stored in the responsible staff member storage means 23, since the customer schedule created by the customer scheduling means 24 is automatically incorporated, it is possible to reliably incorporate the customer planning information included in the customer schedule into the personal schedule for the responsible staff member, thereby reliably preventing a scheduling mistake from occurring.

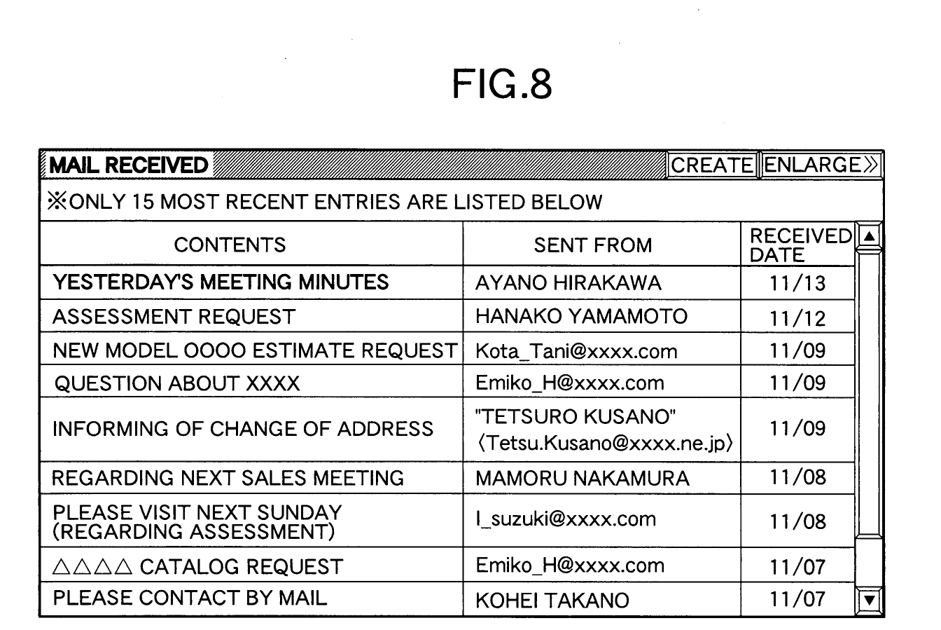

Mail receiving means 27 is connected to the staff member personal schedule storage means 26, and a schedule produced by an electronic mail received by the mail receiving means 27 is written into the staff member personal information 26a, 26b, 26c, etc. FIG. 8 shows the screen of the monitor of the computer terminal 12 on which the contents of an electronic mail received by the mail receiving means 27 are displayed.

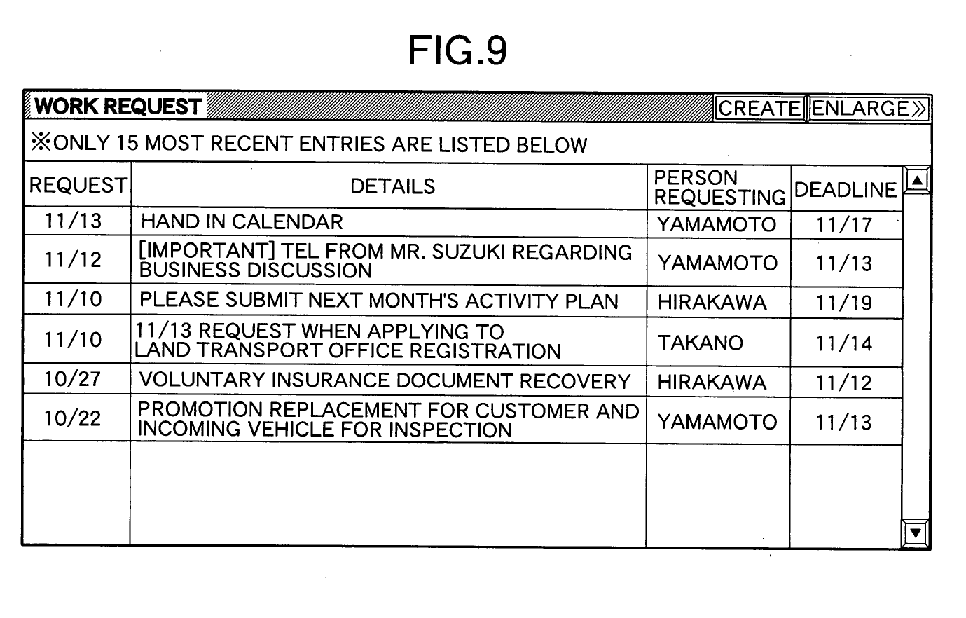

A request for work between staff members inputted via the computer terminal 12 is stored in work request information storage means 29 via work requesting means 28. Among the information stored in the work request information storage means 29, information relating to customer planning is inputted into the customer planning information input means 16, and stored in the customer planning information storage means 15. FIG. 9 shows the screen of the monitor of the computer terminal 12 on which are displayed the contents of the work requests to Mr. Kimura, who is a staff member, the contents including work request date, the details of the work, the person requesting the work, deadline for the work, etc.

The work request information storage means 29 is connected to the staff member personal schedule storage means 26, and the work stored in the work request information storage means 29 is written to the staff member personal information 26a, 26b, 26c, etc. of the staff member who will carry it out.

When a main responsible staff member is unavailable and cannot respond to the customer, the main responsible staff member stores the information in the responsible staff member storage means 22 via the responsible staff member setting means 22. During this process, follow-up staff member setting means 30 has the function of referring to the customer history and automatically setting a follow-up staff member who can replace the main responsible staff member. The personal schedule of a staff member who can respond is updated with this result, while confirming that there are no conflicts in the schedule of each staff member. When there is no staff member who can respond, a warning is sent to an administrator via, for example, the screen of the computer terminal 12.

The follow-up staff member setting means 30 connected to the interviewer storage means 19 sets as a follow-up staff member, among staff members who have interviewed the customer other than the main responsible staff member, the staff member who has interviewed the customer most recently, and the follow-up staff member is inputted into the responsible staff member storage means 23.

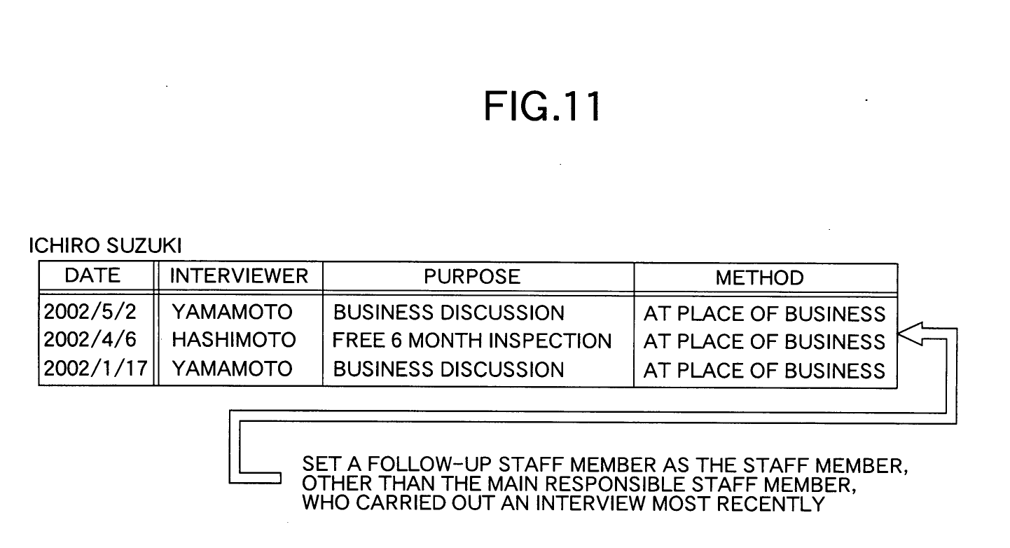

For example, as shown in FIG. 11, when the history shows that Ms. Yamamoto, who is a staff member, interviewed Mr. Suzuki, who is a customer, on January 17th, Mr. Hashimoto, who is a staff member, interviewed Mr. Suzuki on April 6th, and Ms. Yamamoto, who is a staff member, interviewed Mr. Suzuki on May 2nd, Ms. Yamamoto, who is the staff member who interviewed Mr. Suzuki most recently, is set as the follow-up staff member.

In this embodiment, the follow-up staff member is set based on the interview record, but the follow-up staff member may be set according to the intended purpose. For example, when the purpose for which the customer visits the place of business this time relates to an inspection, Mr. Hashimoto, who conducted an inspection interview, is set as the follow-up staff member based on the information of FIG. 11 stored in the customer history storage means 17. As an alternative method, the staff member who has carried out the largest number of interviews (in this case Ms. Yamamoto, two times) may be selected.

In this way, even when the main responsible staff member is absent, by setting a follow-up staff member who is acquainted with the customer to respond, it is possible to achieve smooth communication between the customer and the follow-up staff member, thus enhancing customer satisfaction. In particular, since the staff member, other than the main responsible staff member, who has interviewed the customer most recently is set as the follow-up staff member, communication between the customer and the follow-up staff member can be carried out yet more smoothly.

An embodiment of the present invention is explained above, but the present invention can be modified in a variety of ways without departing from the spirit and scope thereof.

For example, in the embodiment the customer planning information management system used by an automobile sales company is explained, but the present invention is not limited to an automobile sales company and may be applied to any sales company.

1. A customer planning information management system comprising:
customer planning information input means (16) for inputting a plurality of types of customer planning information;
customer planning information storage means (15) for storing the customer planning information inputted by the customer planning information input means (16); and
customer scheduling means (24) for creating a customer schedule by selecting, among the customer planning information stored in the customer planning information storage means (15), a predetermined type of customer planning information on a predetermined date.

2. The customer planning information management system according to claim 1, wherein the predetermined type of customer planning information includes at least information about a visit from a customer to a place of business.

3. The customer planning information management system according to claim 1, wherein it further comprises:
responsible staff member setting means (22) for setting a responsible staff member for a customer;
responsible staff member storage means (23) for storing the responsible staff member for the customer set by the responsible staff member setting means (22); and
staff member personal schedule creating means (25) for creating a personal schedule for the responsible staff member stored in the responsible staff member storage means (23);
the staff member personal schedule creating means (25) creating the personal schedule for the responsible staff member by automatically incorporating the customer schedule created by the customer scheduling means (24).

4. The customer planning information management system according to claim 1, wherein it further comprises;
history input means (20) for inputting at least a history of interviews with a customer;
customer history storage means (17) for storing the history inputted by the history input means (20); and
follow-up staff member setting means (30) for automatically setting a follow-up staff member who replaces a main responsible staff member for the customer based on the history of responding to the customer stored in the customer history storage means (17).
